(19) United States
(12) Patent Application Publication
(10) Pub. No.: US 2025/0370166 A1
(43) Pub. Date: Dec. 4, 2025

(54) OPTICAL SYSTEM FOR A VEHICLE COMPRISING A CAMERA

(71) Applicant: VALEO VISION, Bobigny (FR)

(72) Inventors: Pierre RENAUD, Bobigny (FR); Pierre ALBOU, Bobigny (FR)

(73) Assignee: VALEO VISION, Bobigny (FR)

(21) Appl. No.: 18/875,236

(22) PCT Filed: Jun. 6, 2023
(86) PCT No.: PCT/EP2023/065053

§ 371 Date: Dec. 16, 2024

(30) Foreign Application Priority Data
Jun. 17, 2022 (FR) FR2205928

(51) Int. Cl. G02B 1/14

(52) U.S. Cl. CPC G02B 1/14

(57) ABSTRACT

The invention relates to an optical system for a vehicle. The optical system includes a camera configured to acquire images of the environment outside the vehicle, a protective outer lens configured to be arranged to face the camera. The protective outer lens including an outer face facing the outside of the vehicle and an inner face facing the camera, with the inner face of the protective outer lens having a local radius of curvature defined so that the protective outer lens has a focal length that tends toward infinity.

### TECHNICAL FIELD

The present invention relates to an optical system for a vehicle comprising a camera. It is particularly applicable, but not limited, to automotive vehicles.

### BACKGROUND OF THE INVENTION

In the field of automotive vehicles, an optical system for a vehicle that is known to a person skilled in the art comprises:
a camera configured to acquire images of the environment outside said vehicle,
a protective outer lens configured to be arranged to face said camera, said protective outer lens comprising an outer face facing the outside of said vehicle and an inner face facing said camera.

The protective outer lens is configured to conceal the camera so that it is not visible from outside the vehicle.

A drawback of this prior art is that the protective outer lens affects the performance of the camera because of the curved shape of the protective outer lens and/or the semi-transparency or opacity thereof.

In this context, the present invention is intended to propose an optical system for a vehicle comprising a camera that solves the drawback mentioned.

### SUMMARY OF THE INVENTION

To this end, the invention proposes an optical system for a vehicle comprising:
a camera configured to acquire images of the environment outside said vehicle,
a protective outer lens configured to be arranged to face said camera, said protective outer lens comprising an outer face facing the outside of said vehicle and an inner face facing said camera,
characterized in that said inner face of said protective outer lens has a local radius of curvature R2 defined so that the protective outer lens has a focal length that tends toward infinity.

Thus, as will be seen in detail below, defining the local radius of curvature to have a focal length of the protective outer lens toward infinity provides an optically neutral protective outer lens, which thus does not reduce the performance levels of the camera.

According to nonlimiting embodiments, said optical system may further include one or more of the following additional features, implemented alone or in any technically possible combination.

According to one nonlimiting embodiment, said local radius of curvature R2 is such that R2=R1−(n−1) d/n, where R1 is a local radius of curvature of said outer face, d is a local thickness of said protective outer lens, and n is the refractive index of said protective outer lens.

According to one nonlimiting embodiment, said camera is an RGB or infrared camera.

According to one nonlimiting embodiment, said outer face has a set of local radii of curvature R1.

According to one nonlimiting embodiment, said inner face has a set of local radii of curvature R2.

A protective outer lens for a vehicle configured to be arranged to face a camera carried on board said vehicle is also proposed, said protective outer lens comprising an outer face facing the outside of said vehicle and an inner face facing said camera,
characterized in that said inner face of said protective outer lens has a local radius of curvature R2 defined so that said protective outer lens has a focal length that tends toward infinity.

According to nonlimiting embodiments, the protective outer lens may further include one or more of the following additional features, implemented alone or in any technically possible combination.

According to one nonlimiting embodiment, said local radius of curvature R2 is such that R2=R1−(n−1) d/n, where R1 is a local radius of curvature of said outer face, d is a local thickness of said protective outer lens, and n is a refractive index of said protective outer lens.

According to one nonlimiting embodiment, said outer face has a set of local radii of curvature R1.

According to one nonlimiting embodiment, said inner face has a set of local radii of curvature R2.

### BRIEF DESCRIPTION OF DRAWINGS

The invention and the different applications thereof will be better understood from reading the description below and studying the accompanying figures:

FIG. 1 illustrates an optical system for a vehicle comprising a camera and a protective outer lens arranged to face said camera, said protective outer lens comprising an outer face and an inner face, according to a nonlimiting embodiment of the invention,

FIG. 2 illustrates an infinite focal length of said protective lens of the optical system in FIG. 1 compared to a shorter focal length of a prior art, according to a nonlimiting embodiment,

FIG. 3 illustrates an optical transfer function curve of a camera of a prior art optical system without a protective outer lens,

FIG. 4 illustrates an optical transfer function curve of the camera with the protective outer lens of the optical system in FIG. 1, and

FIG. 5 illustrates an optical transfer function curve of a camera of a prior art optical system with a protective outer lens.

### DETAILED DESCRIPTION OF THE INVENTION

Elements that are structurally or functionally identical and that appear in several figures keep the same reference signs, unless specified otherwise.

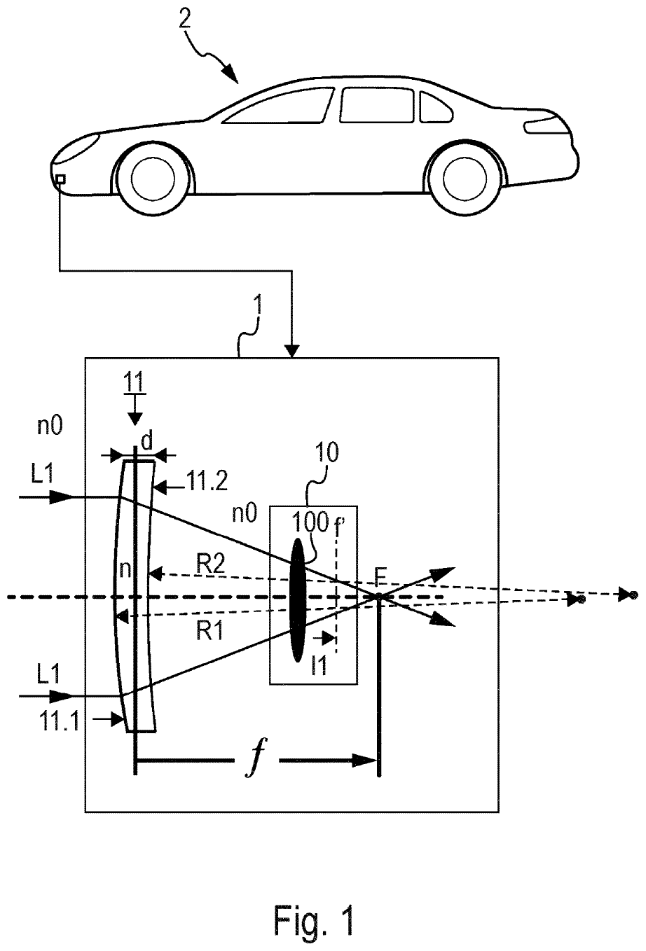

The optical system 1 for a vehicle according to the invention is described with reference to FIGS. 1 to 5. In a nonlimiting embodiment, the vehicle 2 is an automotive vehicle. Automotive vehicle means any type of motorized vehicle. This embodiment is considered, by way of non-limiting example, in the remainder of the description. In the remainder of the description, the vehicle 2 is thus also referred to as an automotive vehicle 2. The automotive vehicle 2 comprises said optical system 1.

As illustrated in FIG. 1, the optical system 1 comprises:
a camera 10 configured to acquire images I1 of the environment outside said automotive vehicle 2, the acquisition of the images I1 taking place in the image focal point f of the optical system 100 of the camera 10,
a protective lens 11 configured to be arranged to face said camera 10.

In nonlimiting embodiments, the optical system 1 is built into:
a logo,
a pivoting logo,
a rear-view mirror,
a third brake light, otherwise referred to as a center high-mounted stop lamp (CHSML),
in the trunk bar,
in the front-end grille of the automotive vehicle 2,
at the rear of the automotive vehicle 2.

Where the optical system 1 is built into the logo or pivoting logo, the protective outer lens 11 forms part of the logo or pivoting logo.

In nonlimiting embodiments, the camera 10 is an RGB camera or an infrared camera. In one nonlimiting embodiment, the camera 10 is a FishEye™ camera. The light rays L1 (illustrated in FIG. 1) from external light sources, such as natural light in a nonlimiting example, illuminate a scene outside the automotive vehicle 2, enabling said scene to be viewed using the optical system of the camera 10 which acquires images I1 of said scene.

In nonlimiting embodiments, the camera 10 is used for:
assisted-parking functions, known as “rear view” or “surround view” (with a range of 0 to 30 meters in a nonlimiting example),
a rear-view mirror function (with a range of about 80 to 200 meters in a nonlimiting example).

The protective outer lens 11 is configured to conceal the camera 10 from the outside of the automotive vehicle 2 but also makes it possible to define a stylized shape specific to an automotive vehicle manufacturer. In nonlimiting embodiments, it is semi-transparent or opaque or transparent.

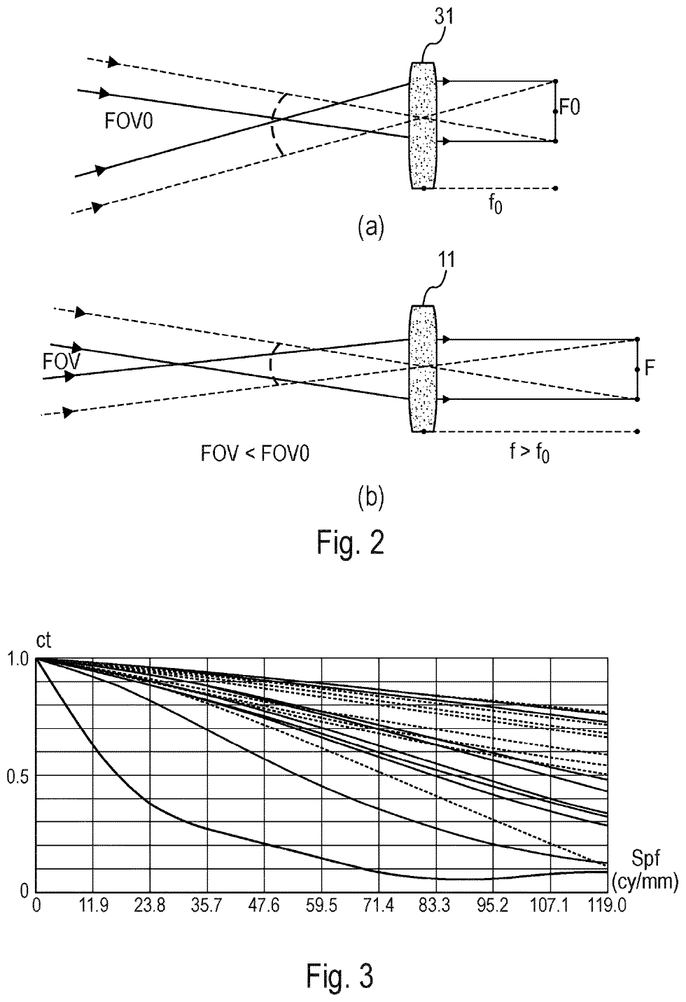

The protective outer lens 11 has a focal point F and a focal length f and a field of view FOV (illustrated in FIG. 2). The protective outer lens 11 also has a thickness d. The protective outer lens 11 comprises an outer face 11.1 arranged to face the outside of the automotive vehicle 2 and an inner face 11.2 arranged to face the camera 10.

In a nonlimiting embodiment, the outer face 11.1 is convex while the inner face 11.2 is concave, or vice versa. In another nonlimiting embodiment, the outer face 11.1 and the inner face 11.2 are both convex, or the outer face 11.1 and the inner face 11.2 are both concave.

In one nonlimiting embodiment, the protective outer lens 11 is made of polycarbonate (PC). The PC provides a robust outer face, which does not break unlike PMMA (poly-methyl methacrylate). In another nonlimiting embodiment, the protective lens 11 is made of PMMA.

The stylized shape of the protective outer lens 11 means that the outer face 11.1 thereof has a set of local radii of curvature R1 which are defined by the stylized shape. In turn, the inner face 11.2 has a set of local radii of curvature R2 adapted to the different local radii of curvature R1 of the outer face 11.1.

The thickness d of the protective outer lens 11 and the radius of curvature R2 of the inner face 11.2 are varied so as to maximize the focal length f of the protective outer lens 11. This provides an optically neutral protective outer lens 11. The focal length f thus tends toward infinity to avoid deflecting the light rays L1 coming from the outside onto the camera 10. Indeed, if the light rays L1 are deflected, this distorts the images I1 acquired by the camera 10, which leads to images I1 that are less sharp.

The definition of focal length f is as follows:

$$\frac{1}{f} = ( n - 1 ) [ \frac{1}{R 1} - \frac{1}{R 2} + \frac{( n - 1 ) d}{n R 1 R 2} ] \qquad [ Math 1 ]$$

where:
   R1 is a local radius of curvature of said outer face 11.1, otherwise referred to as the external radius of curvature R1,
   R2 is a local radius of curvature of the inner face 11.2, otherwise referred to as the internal radius of curvature R2,
   d is a local thickness of said protective outer lens 11, and
   n is the refractive index of light (otherwise referred to as the refractive index n) of said protective outer lens 11.

On the basis of the formula [Math 1], if the focal length f is inclined toward infinity, the inner face 11.2 of the protective outer lens 11 has a local radius of curvature R2 such that R2=R1−(n−1)d/n [2]. Thus, the internal local radius of curvature R2 is always smaller than the external local radius of curvature R1.

This provides an optically neutral protective outer lens 11 which retains the manufacturer's stylized shape since the outer face 11.1 is not modified.

In a nonlimiting example, the protective outer lens 11 comprises the following features:
n the refractive index of light equal to 1.58 for a polycarbonate protective outer lens 11,
the thickness d is 2.5 mm (millimeters),
at the bottom of the protective outer lens 11, the external local radius of curvature R1 is equal to 150 mm,
at the center of the protective outer lens 11, the external local radius of curvature R1 is equal to 177 mm, and
at the top of the protective outer lens 11, the external local radius of curvature R1 is equal to 195 mm.

Adapting the internal local radius of curvature R2 with the formula [2] gives:
at the bottom of the protective outer lens 11, the internal local radius of curvature R2 is equal to 149.08 mm,
at the center of the protective outer lens 11, the internal local radius of curvature R2 is equal to 176.08 mm, and—at the top of the protective outer lens 11, the internal local radius of curvature R2 is equal to 194.08 mm.

The drawing (a) in FIG. 2 illustrates a protective outer lens 31 from the prior art with a focal length f0 and a focal point F0. The drawing (b) in FIG. 2 illustrates a protective outer lens 11 with a focal length f in which the inner face 11.2 comprises a local radius of curvature R2=R1−(n−1) d/n. As shown, the focal length f is larger than the focal length f0. Furthermore, the field of view FOV of the protective outer lens 11 is smaller than the field of view FOV0 of the protective outer lens 31 in the prior art, which means that the light rays L1 are less deflected and therefore converge further away toward the focal point F. Therefore, f>f₀.

FIGS. 3 to 5 illustrate optical transfer function (OTF) curves for respectively:
a camera 10 without a protective outer lens,
a camera 10 arranged to face the protective outer lens 11 defined with an internal radius of curvature R2 adapted to have a focal length f which tends toward infinity,
a camera 10 arranged to face a protective outer lens 31 of the prior art defined with an unadapted radius of curvature R2.

The curves correspond to different angles of incidence (between 0° and 97°) of the light rays L1 reaching the optical system 100 of the camera 10.

The optical transfer function curves in FIG. 2 are used as reference.

An optical transfer function curve is used to evaluate the ability of elements of an optical system such as a camera with or without a protective outer lens to restore contrast according to the sharpness of the details of a target object; in other words, its ability to transmit the spatial frequencies of the target object. It is used to evaluate the quality of the optical system 100. It can therefore be used to evaluate the ability of a protective outer lens 11 to not degrade the performance levels of the camera 10 compared to a camera 10 without a protective outer lens or with a protective outer lens 31 from the prior art.

The contrast between 0 and 1 is plotted on the y-axis of the curves (referenced ct). The spatial frequency of the target object is plotted on the x-axis in cycles/millimeters (referenced Spf (cy/mm)). This represents the sharpness of the detail of the target object.

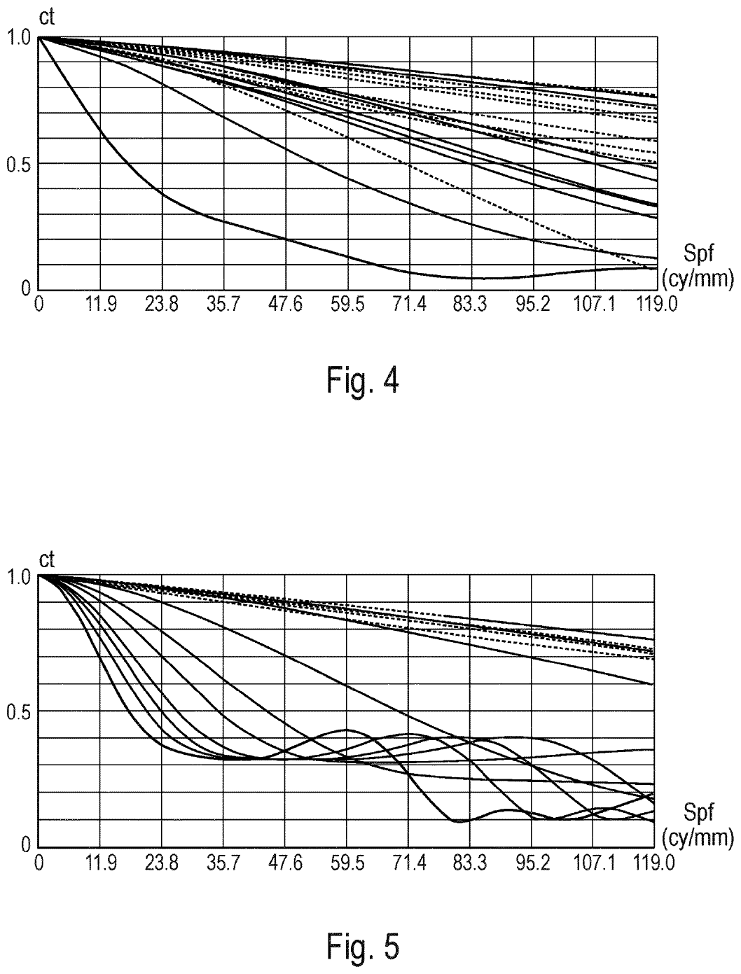

As shown in FIG. 4, with an optimized protective outer lens 11, i.e. with an adapted internal radius of curvature R2, the optical transfer function (OTF) is not degraded at any angle of incidence considered. Almost the same curves are obtained as in the case of FIG. 3, i.e. without a protective outer lens. On the other hand, as shown in FIG. 5, this is not the case with a non-optimized protective outer lens 31 from the prior art, i.e. with an unadapted internal radius of curvature R2, the obtained curves are totally different from the curves in FIG. 3.

Thus, the protective outer lens 11 of the optical system 1 achieves the same performance levels for the camera 10 arranged to face same as a camera 10 with no protective outer lens. Thus, the protective outer lens 11 does not interfere with the camera 10.

Of course, the description of the invention is not limited to the embodiments described above and to the field described above.

The invention described thus notably has the following advantages:
it allows a camera 10 to be incorporated behind a protective outer lens 11 without reducing the performance levels of the camera 10,
it allows the stylized shape given to the protective outer lens 11 by the automotive vehicle manufacturer to be retained because it does not modify the outer face 11.1 thereof,
it provides an optically neutral protective outer lens 11 by locally adapting the inner face 11.2 of the protective outer lens 11,
it is simple to implement.

What is claimed is:

1. An optical system for a vehicle comprising:
a camera configured to acquire images of the environment outside the vehicle,
a protective outer lens configured to be arranged to face the camera, the protective outer lens including an outer face facing the outside of the vehicle and an inner face facing the camera,
wherein the inner face of the protective outer lens has a local radius of curvature R2 defined so that the protective outer lens has a focal length that tends toward infinity.

2. The optical system as claimed in claim 1, wherein the local radius of curvature R2 is such that R2=R1−(n−1)d/n, where R1 is a local radius of curvature of the outer face, d is a local thickness of the protective outer lens, and n is the refractive index of the protective outer lens.

3. The optical system as claimed in claim 1, wherein the camera is an RGB or infrared camera.

4. The optical system as claimed in claim 1, wherein the outer face has a set of local radii of curvature R1.

5. The optical system as claimed in claim 1, wherein the inner face has a set of local radii of curvature R2.

6. A protective outer lens for a vehicle configured to be arranged to face a camera carried on board the vehicle, the protective outer lens comprising an outer face facing the outside of the vehicle and an inner face facing the camera,
wherein the inner face of the protective outer lens has a local radius of curvature R2 defined so that the protective outer lens has a focal length that tends toward infinity.

7. The protective outer lens as claimed in claim 6, wherein the local radius of curvature R2 is such that R2=R1−(n−1)d/n, where R1 is a local radius of curvature of the outer face, d is a local thickness of the protective outer lens, and n is a refractive index of the protective outer lens.

8. The protective outer lens as claimed in claim 6, wherein the outer face has a set of local radii of curvature R1.

9. The protective outer lens as claimed in claim 6, wherein the inner face has a set of local radii of curvature R2.
